(19) United States
(12) Patent Application Publication
(10) Pub. No.: US 2026/0095793 A1
(43) Pub. Date: Apr. 2, 2026

(54) METHODS, ARCHITECTURES, APPARATUSES AND SYSTEMS FOR REFERENCE MEASUREMENT ACQUISITION FOR SENSING

(71) Applicant: InterDigital Patent Holdings, Inc., Wilmington, DE (US)

(72) Inventors: Remun Koirala, London (GB); Fumihiro Hasegawa, Westmount (CA); Paul Marinier, Brossard (CA); Moon IL Lee, Melville, NY (US); Ghyslain Pelletier, Montreal (CA); Tao Deng, New York, NY (US); Benoit Pelletier, Roxboro (CA)

(21) Appl. No.: 18/902,778

(22) Filed: Sep. 30, 2024

(51) Int. Cl. H04W 24/10

(52) U.S. Cl. CPC H04W 24/10

(57) ABSTRACT

Wireless transmit/receive unit (WTRU) methods and systems are provided for sensing and communications. The WTRU methods and systems include receiving, from a wireless network, sensing configuration information for performing sensing, receiving, from the wireless network, one or more reference measurement conditions, performing candidate measurements of one or more reference signals received from the wireless network based on the sensing configuration information, and determining whether one or more of the candidate measurements satisfy the one or more reference measurement conditions. In response to determining that the one or more of the candidate measurements satisfy the one or more reference measurement conditions, the WTRU methods and systems include determining reference measurements based on the one or more of the candidate measurements, determining a validity duration of the reference measurements, and reporting the reference measurements and the validity duration to the wireless network.

### TECHNICAL FIELD

The present disclosure is generally directed to the fields of communications, software and encoding, including, for example, to methods, architectures, apparatuses, systems related to sensing and communications.

### BACKGROUND

A device (e.g., a user equipment or a wireless transmit/receive unit) that is communicatively coupled to a wireless network may perform sensing-related measurements based on signals from the wireless network.

### SUMMARY

A wireless transmit/receive unit (WTRU) can be configured for sensing candidate measurements and determining reference measurements in order to improve sensing of the WTRU. In some embodiments, a WTRU can perform sensing measurements based on receiving, from a wireless network, sensing configuration information for performing sensing. In addition, the WTRU may receive, from the wireless network, one or more reference measurement conditions, each of which may be used by the WTRU to determine the reference measurements. In some embodiments, the one or more reference measurement conditions include measuring conditions, quality conditions, and consistency measurements. The WTRU may determine the reference measurements based on the performed candidate measurements using at least one of the one or more reference measurement conditions. The WTRU may also determine a validity duration of the reference measurement. In some embodiments, the validity duration of a reference measurement is determined based on (a) a number of candidate measurements used to determine the reference measurement, and/or (b) an uncertainty of the number of candidate measurements. The WTRU may also be configured to report the reference measurements and their respective validity duration to the wireless network. Based on the systems and methods of this disclosure, sensing measurements performed by the WTRU may be improved based on the determined reference measurements by establishing a baseline channel map for the sensing applications of the WTRU, the wireless network, or a transmission reception point (TRP).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 shows an illustrative example of a WTRU and wireless network communicating messages for sensing configuration information to be used by the WTRU that may be used within the communications system illustrated in FIG. 1A;

FIG. 3 shows an illustrative diagram of a wireless network communicating an indication, to the WTRU, to initiate a reference measurement window for performing candidate measurements, in accordance with the present disclosure;

FIG. 4 shows an illustrative diagram of a WTRU performing candidate measurements at two measurement occasions within a valid measurement area, in accordance with the present disclosure;

FIG. 5 shows an illustrative graph of example paths corresponding to candidate measurements, in accordance with the present disclosure;

FIGS. 6A, 6B, and 6C, illustrative graphs of example paths corresponding to candidate measurements performed at different measurement occasions;

FIG. 7 shows an illustrative example of a WTRU and wireless network communicating messages for updated sensing configuration information to be used by the WTRU that may be used within the communications system illustrated in FIG. 1A;

FIG. 8 shows an illustrative example set of candidate measurements and two approaches to determine reference measurements, in accordance with the present disclosure;

FIG. 9 shows a flowchart of a method performed by a WTRU for determining and reporting reference measurements to a wireless network, in accordance with the present disclosure;

FIG. 10 shows a flowchart of a subprocess performed by a WTRU for terminating the determination of reference measurements, in accordance with the present disclosure; and

FIG. 11 shows a flowchart of a subprocess performed by a WTRU for reporting invalid information of candidate measurements to the wireless network.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

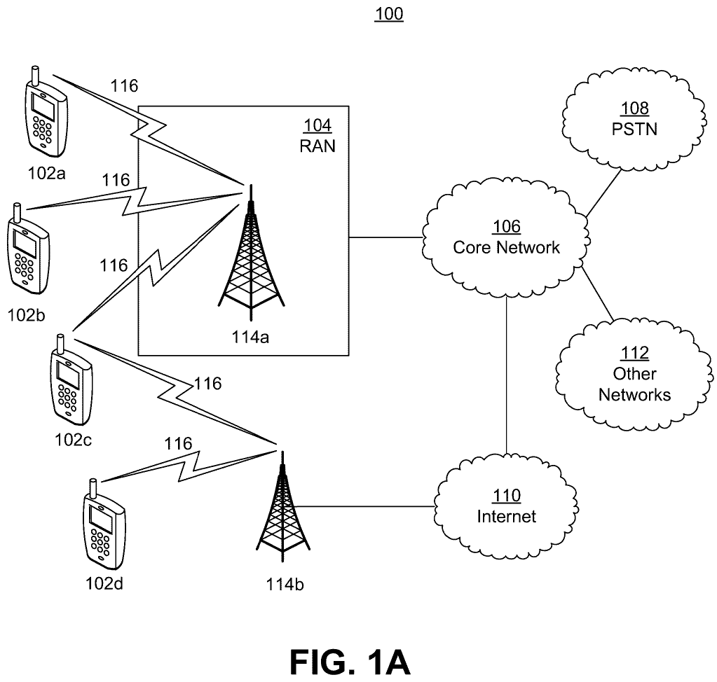

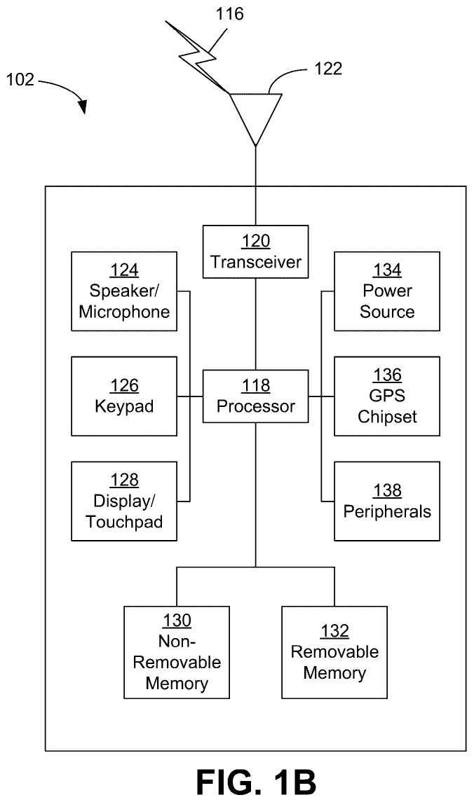

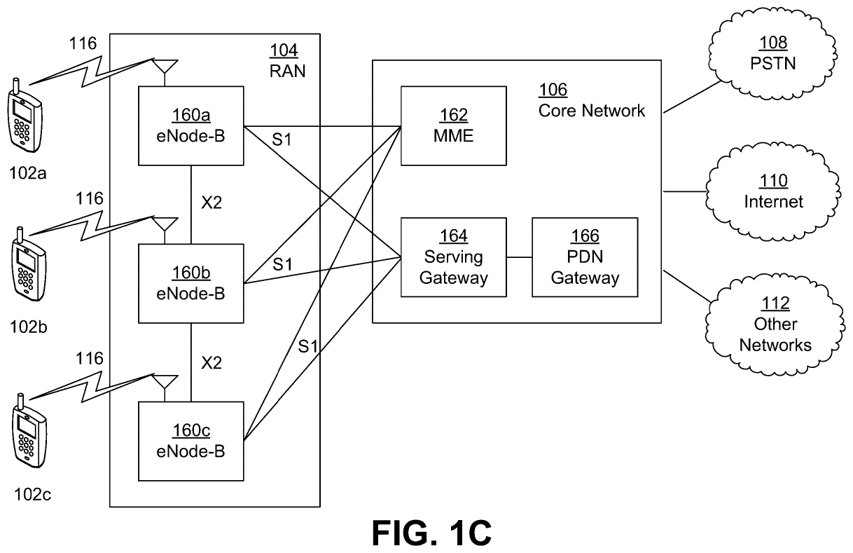

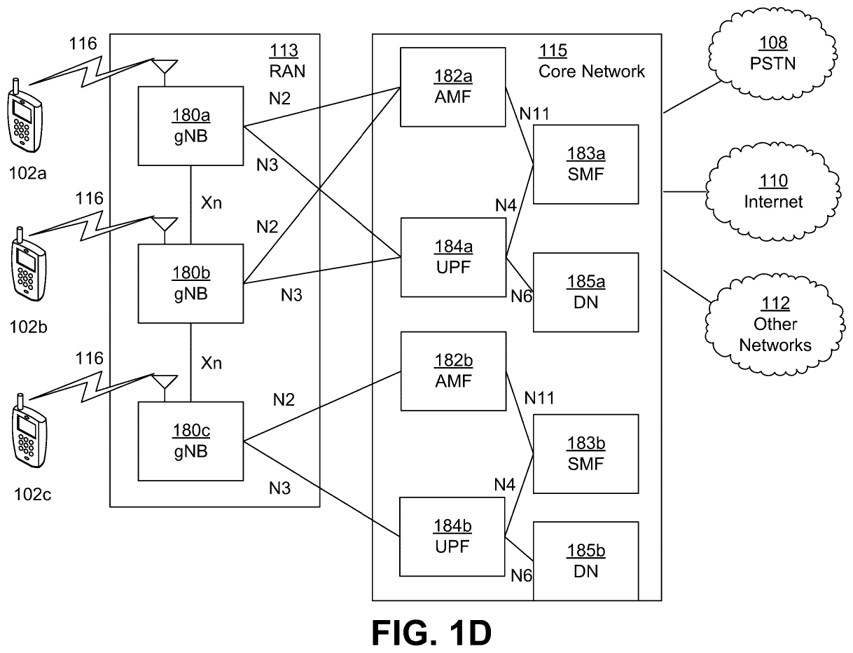

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

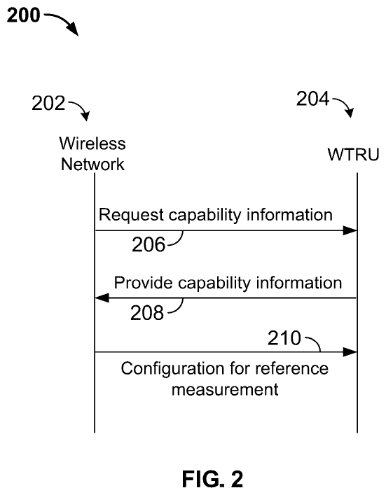

In certain embodiments of the present disclosure, including those described below at least in connection with FIGS. 2-11, the devices, systems, architectures, communication links, apparatuses, and other elements depicted in FIGS. 1A-1D may be used in connection with sensing and determining reference measurements to form a baseline channel map.

The Third Generation Partnership Project (3GPP) for New Radio (NR) lacks certain functionalities or support for sensing. However, various features for NR positioning, including downlink/uplink (DL/UL) reference signals (RSs), architecture, and protocols, may be employed to develop the functionality and support for sensing that 3GPP lacks.

3GPP specifies multipath measurement of the received signal received path power (RSRPP) of DL-positioning reference signals (DL-PRSs), which is used for NR positioning. 3GPP additionally describes per-path reporting of reference signal time difference (RSTD), WTRU receive-transmit (Rx-Tx) time difference, and DL-PRS RSRPP measurements.

In certain embodiments of the present disclosure, knowledge of the surrounding environment may be useful when determining channel paths which are unobstructed by objects for sensing applications. One way to determine the surrounding environment of a WTRU, the WTRU may establish a baseline channel map, which may be used by the wireless network, the TRP, or the WTRU by comparing the baseline channel map to a channel in the presence of sensing targets or extended objects (EOs) to achieve an improved sensing performance.

Accordingly, to address such problems, a WTRU in certain representative embodiments is configured to determine and report reference measurements and associated validity durations for the reference measurements based on various conditions (e.g., one or more reference measurement conditions) as described herein. The WTRU receives one or more configurations (e.g., DL-PRS configurations) for sensing and determines reference measurements and a corresponding reference measurement window from the wireless network. The WTRU then receives, from the wireless network, the reference measurement conditions of which at least one may be used for determining reference measurements. In some embodiments, the reference measurement conditions include at least one of the following: (1) measuring conditions (e.g., conditions based on WTRU location, and/or WTRU mobility, the reference measurement window, or the measurement range), (2) quality conditions (e.g., conditions based on measurement thresholds), or (3) consistency conditions (e.g., conditions based on measurement difference thresholds).

The WTRU may then receive resources (e.g., DL-PRS resources) to perform candidate measurements on more than one measurement occasion during the reference measurement window. The WTRU then determines whether one or more candidate measurements may be used to determined one or more reference measurements (e.g., of a path). In some embodiments, the WTRU determines the reference measurements based on at least one of the following conditions: (1) the candidate measurements satisfy the measuring conditions (e.g., the WTRU is located in a pre-configured measurement area, and/or the candidate measurements were performed within the reference measurement window), (2) the candidate measurements satisfy the quality conditions (e.g., each of the candidate measurement is above a threshold), or (3) the candidate measurements satisfy the consistency conditions (e.g., the difference between candidate measurements on two occasions is below a threshold), or any combination thereof.

The WTRU may determine the validity duration of the reference measurement, which, in some embodiments, is based on the number of candidate measurements used to determine the reference measurement and/or the uncertainty of each candidate measurement used to determine the reference measurement. Once the WTRU determines the validity duration of the reference measurement, the WTRU reports the reference measurements and the validity duration to the wireless network.

In some embodiments, the WTRU terminates the process of determining reference measurement based on a determination that a number of measurement occasions at which candidate measurements were performed that do not satisfy one or more of the reference measurement conditions is above a pre-configured threshold.

The methods, systems, and architectures described herein enable the wireless network to request the WTRU to perform sensing candidate measurements and determine reference measurements based on certain criteria (e.g., sensing configuration information and reference measurement conditions) that may include: the information included in the sensing configuration information (e.g., DL-PRS configuration) according to which the WTRU may perform candidate measurements, the quality of the reference measurements which the WTRU may report, and/or the consistency of reference measurements which the WTRU may report. These reference measurements determined by the WTRU may be used by the wireless network or the WTRU to build a baseline channel map of the environment and perform sensing based on the baseline channel map.

### Common Terminology

In this disclosure, the term “TRP” may be used interchangeably with “gNB”, “Positioning reference unit (PRU)”, “sensing transmitter”, or “UE”. The term “TRP” may be used to indicate an entity (e.g., RAN entity) capable of transmitting a RS, e.g., DL-PRS, synchronization signal burst (SSB), channel state information-reference signal (CSI-RS). The term “UE” may be used interchangeably with “sensing receiver” and may be used to indicate an entity (e.g., RAN entity) capable of receiving and measuring a RS, e.g., DL-PRS, SSB, CSI-RS. The term “Network” may refer to the access mobility management function (AMF), location management function (LMF), gNB, next-generation random access network (NG RAN), or any other entity involved in sensing functionalities, e.g., sensing management function (SMF). The term “location” may be used interchangeably with “position”, and a location (e.g., WTRU location, TRP location) may be expressed in terms of altitude, latitude, geographic coordinate, or local coordinate. The terms “reference signal (RS)” and/or “positioning reference signal” may refer to any of the positioning and reference signals, e.g., DL-PRS, Sounding Reference Signal for Positioning (SRSp), CSI-RS, demodulation-reference signal (DM-RS), SSB. The WTRU may receive one or more configured thresholds from the wireless network (e.g., LMF, gNB) via a physical downlink channel (e.g., physical downlink shared channel (PDSCH), physical downlink control channel (PDCCH)) or via lower or higher layer signaling, e.g., downlink control information (DCI), medium access control-control element (MAC-CE), radio resource control (RRC), or LTE positioning protocol (LPP) message. An LMF is a non-limiting example of a node or entity (e.g., a wireless network node or entity) that may be used for or to support positioning and/or sensing. Any other node or entity (e.g., server WTRU, SMF) may be substituted for LMF and still be consistent with this disclosure. The term “ID” may be used interchangeably with “index”. The term “path” may be used interchangeably with “multipath”. The WTRU may receive configurations (e.g., RS configurations, measurement configurations, reporting configurations), assistance information, indications, and/or messages from the wireless network (e.g., LMF, gNB) via a downlink physical channel (e.g., PDSCH, PDCCH) or via lower or higher layer signaling (e.g., DCI, MAC-CE, RRC, or LPP message). The terms “DL-PRS”, “PRS”, “DL-PRS”, and “DL-RS” may be used interchangeably herein. “DL-PRS ID(s)”, “DL-PRS resource ID(s)”, “DL-PRS beam ID”, and/or “DL-PRS resource ID(s)”may be associated with one or more TRPs.

In one example, the WTRU sends capability information, a report containing the one or more reference measurements, indications, and/or requests to the wireless network (e.g., LMF, gNB) via a semi-static message (e.g., LPP, RRC) or dynamic message (e.g., uplink control information (UCI), or MAC-CE).

A maximum value and a minimum value (e.g., of candidate measurements) may correspond to an absolute range or a relative range (e.g., with respect to an expected value).

An area may be defined as a region and in terms of one or more of a coarse location, a zone ID, or any other representation of a graphical area, such as a set of points (e.g., convex hull around a point), a location representing center of a shape (e.g., a rectangle) and associated parameters. In some examples, an area may be defined in terms of a coarse location including an ellipsoid point (e.g., defined by latitude degree, longitude degree, or latitude sign, or any combination thereof) or a geographical location (e.g., 2D location, 3D location). The area may additionally include an uncertainty region (e.g., a circle, sphere, ellipse, ellipsoid). In another example, an area may be defined in terms of a zone ID with reference to a geographical reference (e.g., (0, 0)) and may refer to a geographical area, such as a square area defined by a point and a zone length L of the square. For a given zone length L, which may be configured by the wireless network, the WTRU may be able to determine the area based on the zone ID and a mathematical mapping equation or a table.

The term “measurements” or “candidate measurements” may correspond to at least one of reference signal received power (RSRP), RSRPP, relative delay, doppler shift, angle of arrival (AoA), or phase measurements. In one example, the candidate measurement is per-path, per-DL-PRS resource, per-DL-PRS resource set, or per-DL-PRS beam. The “measurements” may also correspond to a set of candidate measurements or an average (e.g., mean, median, mode) of the set of candidate measurements. In one example, the set of candidate measurements includes candidate measurements of one or more paths.

A time indication (e.g., transmission time, timestamp) may be indicated by absolute time, relative time (e.g., in seconds) compared to a reference time, system frame number (SFN), slot index, frame index, subframe index and/or symbol index. Examples of “absolute time” include UTC time, GNSS time, and locally defined absolute time (e.g., LTE or NR Time).

The examples herein are focused on measurement and reporting procedures for reference measurements. However, the methods and procedures discussed herein may be implemented for any measurement or reporting procedures for sensing.

The conditions for determination of one parameter (e.g., configuration parameter related to at least one procedure) may depend on one or more factors. The WTRU may determine one value for the parameter based on determining that at least one of the factors are above a configured threshold (e.g., a pre-configured threshold), and another value for the parameter based on determining that the factor is below a configured threshold (e.g., a pre-configured threshold).

### Sensing Configuration Information

In some embodiments, sensing configuration information (e.g., a DL-PRS configuration) used by the WTRU for performing candidate measurements includes at least one of the following parameters: a number of symbols, transmission power, a number of resources (e.g., DL-PRS resources) included in an available resource set (e.g., DL-PRS resource set), a muting pattern for DL-PRS implementations (e.g., expressed via a bitmap), a periodicity, a type of DL-PRS (e.g., periodic, semi-persistent, or aperiodic), a slot offset for periodic transmission for DL-PRS, a vertical shift of a DL-PRS pattern in the frequency domain, a time gap during repetition, a repetition factor, a resource element (RE) offset, a comb pattern, a comb size, a spatial relation, quasi co-location (QCL) information (e.g., QCL target, QCL source) for DL-PRS, a number of PRUs, a number of TRPs, an absolute radio-frequency channel number (ARFCN), subcarrier spacing, an expected RSTD, an uncertainty in expected RSTD, a start physical resource block (PRB), a bandwidth, a bandwidth part (BWP) ID, a number of frequency layers (e.g., positional frequency layers (PFLs)), a start time and an end time for DL-PRS transmission, an on/off indicator for DL-PRS, a TRP ID, a DL-PRS ID, a cell ID, a global cell ID, a PRU ID, and an applicable time window.

In one example, the WTRU applies sensing configuration information (e.g., a DL-PRS configuration) under a condition that the current time is within the applicable time window. The WTRU may receive a beam width of a DL-PRS or a boresight direction, e.g., an angle of departure (AoD), of DL-PRS from the wireless network. Although examples provided herein include DL-PRS configurations, the sensing configuration information described herein is not limited to DL-PRS and may be applicable to any DL RS, or any suitable configuration for sensing.

### Configuration for Reference Measurements

In some embodiments, the WTRU receives, from the wireless network (e.g., an LMF, a gNB, or an entity that configures RSs to the WTRU), the configuration (e.g., a DL-PRS configuration) for sensing and determining reference measurements in the DL physical channels, e.g., PDSCH or PDCCH via higher layer signaling (e.g., MAC-CE, RRC, DCI, or LPP messages).

In one example, the WTRU receives configurations corresponding to more than one measurement occasions. The WTRU may receive configurations for periodic or semi-static DL-PRS resources to perform candidate measurements.

In some embodiments, the WTRU is configured by the wireless network to perform candidate measurements, determine reference measurements, and/or report the reference measurements. In another example, the WTRU requests sensing configuration information for performing candidate measurements based on at least one of the following trigger conditions: the channel measurements are above or below a configured threshold (e.g., a pre-configured threshold), a difference between channel measurements is below a configured threshold (e.g., a pre-configured threshold), a measured channel delay spread is below a configured threshold (e.g., a pre-configured threshold), a measured channel doppler spread is below a configured threshold (e.g., a pre-configured threshold), a measured coherence bandwidth is above a configured threshold (e.g., a pre-configured threshold), the WTRU detects multiple paths in a channel measurement, the WTRU receives a request from the wireless network (e.g., gNB, LMF) to perform candidate measurements, or the WTRU determines to observe the reference channel path before starting a sensing procedure and/or requesting sensing configuration information from the wireless network. The channel measurements may include at least one of the following: (1) RSRP, (2) reference signal received quality (RSRQ), or (3) signal-to-interference noise ratio (SINR) of the RS (e.g., CSI-RS, or SSB).

FIG. 2 shows an illustrative example 200 of a WTRU 204 responding to a capability request 206 with capability information 208 and subsequently receiving a configuration for performing reference measurements 210. In some embodiments, one or more of WTRUs 102a, 102b, 102c, 102d of communications system 100 may be implemented as WTRU 204. In some embodiments, RAN 104/113 of communication system 100 may be implemented as wireless network 202.

In some embodiments, the wireless network 202 sends a request for capability information 206 to the WTRU 204. The WTRU 204 determines and reports capability information 208 to the wireless network, e.g., for performing reference measurements. The capability information report 208 may include one or more of the following: capability to perform one or more measurements (e.g., per-path measurements, per-DL-PRS resource measurements), which include at least one of RSRP, RSRPP, phase, AoA, relative delay (e.g., with respect to a reference path), or doppler shift measurements, capability to obtain and process multiple measurements (e.g., a maximum number of measurements N₁) associated with one or more paths and/or one or more measurement occasions, capability to report multiple measurements (e.g., a maximum number of measurements N₂) associated with one or more paths and/or one or more measurement occasions, capability to measure and process measurements corresponding to a maximum number of frequency bands (e.g., a maximum number of PFLs N₃), resource blocks (RBs), resource elements (REs) or frequency components, capability to determine and/or report WTRU location, orientation, and/or velocity (e.g., maximum periodicity of determining and/or reporting WTRU location, orientation, and/or velocity), capability to determine and/or report the error (e.g., synchronization error, measurement error) expressed in time and/or phase, maximum measurement error (e.g., or number of measurement errors) supported for determination and/or reporting of measurements, maximum supported number of paths for one or more measurements (e.g., RSRPP, relative delay, phase), or maximum supported TRPs (e.g., of wireless network 202), DL-PRS resource sets, DL-PRS resources, bandwidth, and/or frequency for determining and/or reporting measurements, or a maximum supported periodicity for determining and/or reporting measurements, or the WTRU location, or whether the WTRU 204 is stationary or mobile.

The WTRU 204 may send the capability information 206 to the wireless network 202 via a semi-static message (e.g., LPP, RRC) or a dynamic message (e.g., UCI, MAC-CE). In one example, the WTRU 204 receives the configuration for reference measurement 210 based on the reported capability information 208. In another example, the WTRU 204 receives a subsequent request from the wireless network 202 to perform candidate measurements for determining reference measurements.

### Assistance information for reference measurements

The WTRU may receive expected parameters related to the reference measurements. For example, the expected parameters may include: an expected delay spread of the channel, a maximum delay of the channel, an expected number of paths, an expected delay profile (e.g., delay for each path in the multipath channel), and an expected RSRPP.

In some embodiments, the WTRU receives one or more reference measurement conditions for determining and/or reporting reference measurements. The WTRU may receive at least one of the following as reference measurement conditions: a reference measurement window, measuring conditions, quality conditions, consistency conditions, or measurement range.

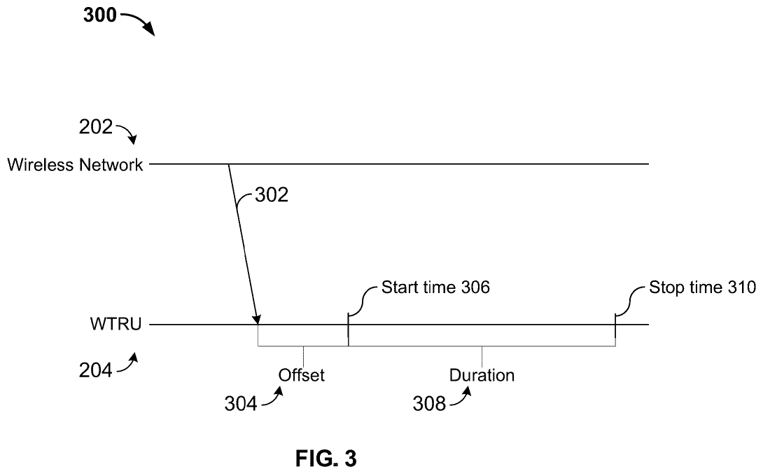

FIG. 3 shows an illustrative example 300 of a WTRU 204 receiving an indication 302 of a reference measurement window 308 from wireless network 202 and performing candidate measurements based on the received reference measurement window 308.

In some embodiments, the WTRU 204 receives the indication 302 (e.g., a DCI indication) to initiate a reference measurement window 308 and the WTRU 204 determines reference measurements, and/or reports the reference measurements based on candidate measurements that were performed within the indicated reference measurement window 308. In some embodiments, the WTRU 204 may send a request to wireless network 202 to configure the reference measurement window 308. The reference measurement window 308 may be indicated by the wireless network 202 in terms of one or more of the following: a start time 306 and/or stop time 310, e.g., expressed in terms of relative time, symbol number, slot number, subframe number or frame number, a duration of the reference measurement window 308, e.g., expressed in terms of relative time or a number of symbols, slots, subframes, or frames, or an offset 304, e.g., expressed in terms of symbol offset, slot offset, subframe offset, frame offset, or relative time offset, periodicity, e.g., expressed in terms of relative time or number of symbols, slots, subframes, or frames.

The relative time (e.g., in seconds, milliseconds), used to indicate reference measurement windows as described, may be with respect to a reference time. The reference time may include at least one of the following: the time instance when the WTRU 204 receives the one or more sensing configurations from the wireless network 202, or the time instance when the WTRU 204 receives an indication 302 from the wireless network to initiate the reference measurement window 308.

In some embodiments, the WTRU 204 may receive one or more measuring conditions for the reference measurements from the wireless network 202, upon satisfaction of which, the WTRU 204 may perform candidate measurements, determine reference measurements, and/or report the reference measurements. In one example, satisfaction of the measuring conditions may trigger the activation of the reference measurement window 308.

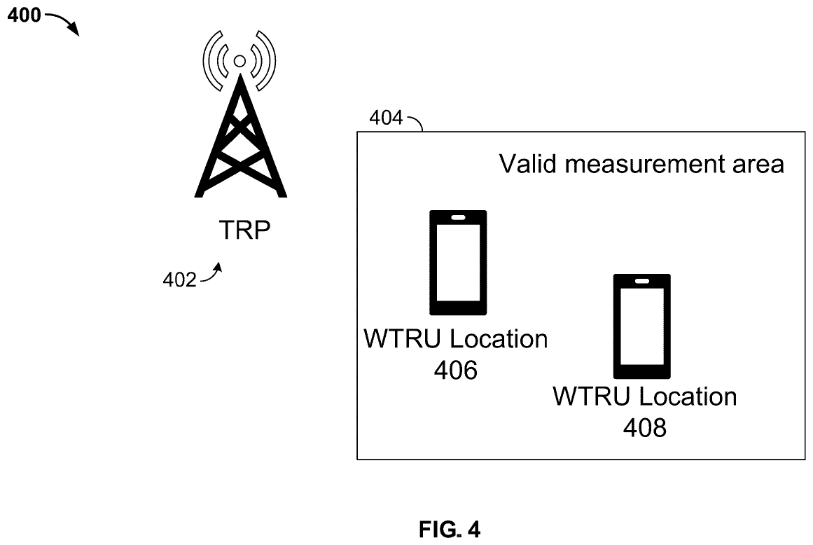

FIG. 4 shows an illustrative diagram 400 demonstrating measurement conditions defined by the location of the WTRU. FIG. 4 depicts a TRP 402 (e.g., of wireless network 202) in connection with a WTRU (e.g., WTRU 204). As shown in FIG. 4, in some embodiments, the measuring conditions include a WTRU location. In one example, the WTRU is configured with a set of locations or area (e.g., a coarse location, geographical area defined by one or more 2D or 3D coordinate points, zone ID, cell ID, covering TRP ID) where the WTRU may perform candidate measurements, determine reference measurements and/or report the reference measurements. In some embodiments, the WTRU may be configured with a valid measurement area 404, wherein the WTRU may perform candidate measurements, determine reference measurements and/or report the reference measurements based on determining that the WTRU location during measurement is within the valid measurement area 404. The WTRU location may be indicated in terms of latitude, longitude, and/or altitude of the WTRU.

In another example, the measuring condition may include a threshold (e.g., a valid distance threshold) for the difference in WTRU location between multiple measurement occasions, wherein the WTRU may determine reference measurements and/or report the reference measurements based on determining that the distance between two WTRU locations corresponding to two measurement occasions is below the indicated threshold. For example, the WTRU at first WTRU location 406 performs a first candidate measurement (e.g., corresponding to a first measurement occasion) and the WTRU then moves to second WTRU location 408, where the WTRU performs a second candidate measurement (e.g., corresponding to a second measurement occasion). In this example, the WTRU has received a measuring condition including a valid distance threshold and remains located within the valid measurement area 404, however, as the distance between the WTRU locations of the first and second candidate measurements (e.g., at first WTRU location 406 and second WTRU location 408, respectively) is greater than the distance threshold, the WTRU does not determine a reference measurement based on either of the first or second candidate measurements based on the candidate measurements being inconsistent. In some implementations, the WTRU may also determine to not perform candidate measurements based on the determination that distance between WTRU locations of candidate measurements exceeds the valid distance threshold.

In some embodiments, the measuring conditions include a WTRU velocity. For example, the WTRU may be configured with a maximum and/or minimum velocity threshold (e.g., in units of meters per seconds), where the WTRU may only perform candidate measurements, determine reference measurements and/or report the reference measurements when the WTRU velocity is below the maximum velocity threshold and/or above the minimum velocity threshold. The maximum and minimum velocity range may be an absolute range or with respect to a reference velocity (e.g., expected velocity). In one example, the reference velocity may be a velocity of the WTRU at a previous occasion (e.g., previous measurement occasion, previous reporting occasion).

In another example, the measuring conditions include a velocity difference threshold (e.g., between two occasions), where based on determining that the WTRU velocity between two occasions is above the velocity difference threshold, the WTRU may determine to not perform candidate measurements, not determine reference measurements and/or not report the reference measurements.

In some embodiments, the measuring conditions include a WTRU orientation. For example, the measuring conditions may include a maximum and/or minimum orientation threshold, e.g., in terms of the global coordinate system (GCS), the local coordinate system (LCS), Euler angles, degrees, radians. The WTRU may perform candidate measurements, determine reference measurements and/or report reference measurements based on determining that the orientation of the WTRU is below the maximum orientation threshold and/or above the minimum orientation threshold. In one example, the measuring conditions consists of an orientation difference threshold between two occasions, where the WTRU may perform candidate measurements, determine reference measurements and/or report reference measurements based on determining that the change in orientation between the occasions is below the orientation difference threshold. Based on a determining that the WTRU rotates by more than a configured amount during the measurement procedure, the WTRU may determine to not perform measurement, determine reference measurements, or report the reference measurements.

In some embodiments, the measuring conditions include a time and/or phase synchronization error. The measuring conditions may include one or more time and/or phase synchronization error thresholds, where the WTRU may perform candidate measurements, determine reference measurements and/or report the reference measurements based on determining that the time and/or phase synchronization errors are below their respective thresholds.

In some embodiments, the measuring conditions include measurements from one or more RS resources. In one example, the WTRU may be configured with one or more RS resources, where the RS may be at least one of SSB, CSI-RS, or DL-PRS, associated with one or more TRPs. The WTRU may monitor one or more measurements associated with the configured RSs, e.g., RSRP, received signal strength indicator (RSSI), SINR, and/or RSRPP of the first path. The WTRU may determine candidate measurements to be reference measurements based on determining that one or more of the measurements associated with the configured RSs is above or below a configured threshold.

In another example, the WTRU may be configured to monitor one or more RSs or RS resources by the wireless network. The measuring conditions may include a start time, end time, periodicity, and/or RS resource IDs for monitoring the RS. For example, the WTRU may perform candidate measurements, determine reference measurements and/or report the reference measurements based on determining that the RSRP of the configured CSI-RS resource is above a configured threshold. In some examples, the configured RS may be the same as or different from the RS for performing candidate measurements for sensing.

In some embodiments, the measuring conditions may include a time range. For example, the WTRU may be configured with one or more time range or time instances, e.g., in terms of time of the day, absolute time (e.g., UTC time, GNSS time), locally defined absolute time (e.g., LTE or NR Time), relative time (e.g., in seconds) compared to a reference time, SFN, slot index, frame index, subframe index and/or symbol index. The WTRU may determine to perform candidate measurements, determine reference measurements, and/or report reference measurements based on determining that the current time or the measurement time is within the indicated time range or time instances.

In some embodiments, the measuring conditions include a line of sight or non-line of sight ID (LoS/NLoS ID). For example, the WTRU may be configured with a LoS/NLoS ID threshold and may determine to perform candidate measurements, determine reference measurements and/or report the reference measurements only the WTRU identifies that a LoS/NLoS ID associated with at least one PRS resource ID, PRS beam ID, PRS resource set ID and/or TRP ID is above the threshold.

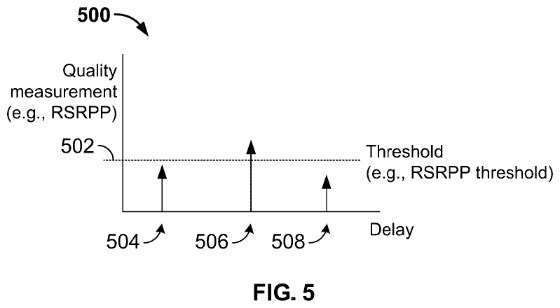

FIG. 5 shows an illustrative example 500 of a path (e.g., path 2 506) that satisfies a quality condition based on the measurement quality exceeding a threshold 502.

As shown in FIG. 5, in some embodiments, the WTRU (e.g., WTRU 204) receives one or more quality conditions. The WTRU may determine reference measurements and/or report the reference measurements based on candidate measurements that satisfy one or more quality conditions.

In some embodiments, quality conditions include one or more reference measurement thresholds. For example, the WTRU may be configured with reference measurement thresholds (e.g., minimum and/or maximum measurement thresholds) associated with one or more TRPs, DL-PRS resources, or paths, and may determine a candidate measurement to be a reference measurement and/or report the reference measurement based on determining that the candidate measurement is above or below the configured threshold. In one example, the WTRU determines that a candidate measurement from a path (e.g., second path 506) satisfies the quality condition based on the measurement quality of the path (e.g., RSRPP) exceeding a threshold (e.g., RSRPP threshold 502). However, the WTRU determines that a candidate measurement from another path (e.g., first path 504 and/or third path 508) does not satisfy the quality conditions based on the measurement quality of the path (e.g., RSRPP) being below the threshold (e.g., RSRPP threshold 502). For example, the WTRU may determine a reference measurement based on one or more candidate measurements that includes candidate measurement of second path 506 but does not include candidate measurements of first path 504 and third path 508.

In some examples, the WTRU (e.g., only) determines reference measurements and/or reports the reference measurements based on a candidate measurement based on the WTRU determining one or more of the following: RSRP of one or more received and/or configured resources (e.g., DL-PRS resources) of the sensing configuration are above the configured minimum RSRP threshold, RSRPP of at least one path of the candidate measurements(e.g., LoS path, k-th path) is above a configured minimum RSRPP threshold, AoA of at least one path of the candidate measurements (e.g., LoS path, k-th path) is within the minimum and maximum AoA range threshold, or the measured doppler shift (e.g., associated with a path) of the candidate measurements is above a configured doppler shift threshold, and/or below the configured maximum doppler shift threshold.

In some embodiments, the quality conditions may include one or more candidate measurement uncertainty and/or resolution thresholds. The WTRU may be configured with a candidate measurement uncertainty threshold. The WTRU may determine the uncertainty associated with one or more candidate measurements and may determine a reference measurement based on the one or more candidate measurements when the uncertainty of the one or more candidate measurements is above a configured threshold. The WTRU may determine the measurement uncertainty for candidate measurements based on at least one of the following: bandwidth (e.g., DL-PRS bandwidth), the candidate measurement (e.g., RSRP, SINR) associated with the received resource (e.g., DL-PRS resource), the number of WTRU antenna elements, phase and/or time synchronization errors, or the sensing configuration information (e.g., DL-PRS configuration).

In some embodiments, the quality conditions may include a number of samples per candidate measurement. In one example, the WTRU is configured with a threshold for the number of measurement samples per candidate measurement and determines a reference measurement based on a candidate measurement when the WTRU determines that the number of measurement occasions for the candidate measurements is above a configured threshold.

In some embodiments, based on determining that one or more of the above-indicated quality conditions are not satisfied, the WTRU determines that a candidate measurement may not be used when determining a reference measurement. The WTRU may further send a report of invalid information of the candidate measurement that does not satisfy the quality conditions and/or the WTRU terminates the reference measurement procedure based on the determination that the candidate measurement does not satisfy the one or more quality conditions. In another example, the WTRU discards a candidate measurement based on determining that at least one of the quality conditions are not satisfied.

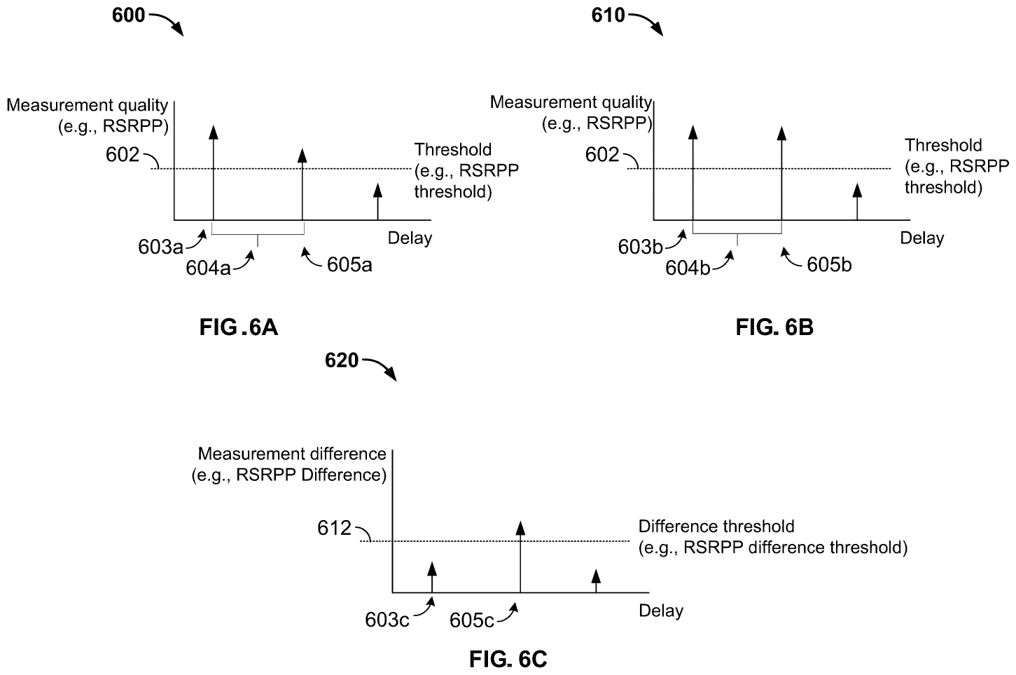

FIGS. 6A-C shows an illustrative example of a path (e.g., path 2) that satisfies a quality condition based on the measurement quality exceeding a threshold but does not satisfy a consistency condition based on the measurement difference exceeding a difference threshold.

As shown in FIGS. 6A-C, in some embodiments, the WTRU (e.g., WTRU 204) receives consistency conditions from the wireless network. The consistency conditions may include a set of conditions, where, upon satisfaction, the WTRU may determine a candidate measurement to be a reference measurement and/or report the reference measurement.

In some embodiments, the consistency conditions include a measurement difference threshold. For example, the WTRU may determine that two candidate measurements are consistent based on determining that their measurement difference (e.g., difference between the two candidate measurements) is above or below the measurement difference threshold. In some embodiments, the two candidate measurements may correspond to different paths, different measurement occasions, different resources (e.g., DL-PRS resources), beams (e.g., DL-PRS beams), resource IDs (e.g., DL-PRS resource IDs), and/or TRPs. In one example, two candidate measurements correspond to candidate measurements of the same path at two measurement occasions, or in another example, they correspond to two candidate measurements for different paths performed at the same measurement occasion.

In one example, the WTRU determines that at a first measurement occasion 600, a candidate measurement for a path (e.g., second path 605a) exceeds a threshold (e.g., RSRPP threshold 602) and satisfies a quality condition, as depicted in FIG. 6A. The WTRU also determines that at a second measurement occasion 610, the candidate measurement for the path (e.g., second path 605b) exceeds a threshold (e.g., RSRPP threshold 602), as depicted in FIG. 6B. However, the WTRU determines that the candidate measurements from the path (e.g., candidate measurements for second path 605a and 605b) are not consistent based on the measurement difference (e.g., RSRPP difference) of the path (e.g., second path 605c) between the first measurement occasion 600 and second measurement occasion 610 exceeding a difference threshold (e.g., RSRPP difference threshold 612), as depicted in graph 620 of FIG. 6C.

In some examples, the WTRU may determine that the consistency conditions are met for two candidate measurements between measurement occasions (e.g., first measurement occasion 600 and second measurement occasion 610) based on one or more of the following: the measured RSRPP associated with a path (e.g., indicated path, direct path, LoS path, n-th path) at two measurement occasions (e.g., first measurement occasion 600 and second measurement occasion 610) is below a configured threshold, the measured relative delay difference between two measurement occasions (e.g., first measurement occasion 600 and second measurement occasion 610) associated with a single path is below a configured threshold, the measured relative phase difference between the candidate measurements is below a configured threshold, or the difference between the RSTD measurements is below a configured threshold.

In other examples, the WTRU may determine a delay (e.g., first delay 604a and second delay 604b) between candidate measurements of two different paths at each measurement occasion (e.g., first measurement occasion 600 and second measurement occasion 610). The WTRU may determine that the consistency conditions of two candidate measurements associated with different paths (e.g., first path and second path) are met based on the difference between the first delay 604a between two candidate measurement of different paths (e.g., first path 603a and second path 605a) at first measurement occasion 600 and the second delay 604b between two candidate measurement of different paths (e.g., first path 603b and second path 605b) at second measurement occasion 610 being above or below a configured threshold. For example, as illustrated in FIG. 6A, the measured (e.g., relative) delay of the candidate measurement of second path 605a relative to the candidate measurement of the first path 603a is first delay 604a at first measurement occasion 600 and the measured (e.g., relative) delay of the candidate measurement of second path 605b relative to the candidate measurement of first path 603b is second delay 604b at second measurement occasion 610. The WTRU determines that the consistency conditions are met for the candidate measurements corresponding to the first path and the second path based on determining that the difference between the second delay 604b and the first delay 604a is below a configured threshold.

In some embodiments, the consistency conditions include one or more reference measurement thresholds. In one example, the WTRU determines two candidate measurements meet the consistency conditions based on a difference between the candidate measurement of a configured reference being below a configured difference threshold, where the candidate measurements are performed at two measurement occasions. For example, the WTRU may be configured with LoS as the reference for the (e.g., relative) excess delay measurement. The WTRU may determine the candidate measurements for relative excess delay at two measurement occasions meet the consistency conditions based on determining that one or more of the following differences are below a configured threshold: the difference between the RSRPP measurements of the reference (e.g., LoS) path, the difference between the AoA measurements of the reference (e.g., LoS) path, the difference between the doppler shift measurement of reference (e.g. LoS) path.

For example, as illustrated in FIG. 6, a reference for (e.g., relative) delay measurement may be configured to be the candidate measurement for first path 603. The WTRU may determine that a candidate measurement meets the consistency conditions based on the RSRPP difference of the candidate measurement for first path 603c between the first measurement occasion 600 and second measurement occasion 610 being below a configured difference threshold (e.g., RSRPP difference threshold 612).

In some embodiments, the consistency conditions may include a channel measurement difference threshold. The WTRU determines differences between channel measurements at two measurement occasions and may determine that a candidate measurement meets the consistency conditions based on the difference between channel measurements being above or below a configured threshold. For example, the WTRU may determine that two candidate measurements meet the consistency conditions based on determining that one or more of the following conditions are true: the difference in the number of measured paths between two measurement occasions is above or below a configured threshold, the difference in the delay spread of the channel between two measurement occasions is above or below a configured threshold, the difference in the doppler spread of the channel between two measurement occasions is below a configured threshold, the difference in coherence bandwidth measured between candidate two measurements is above a configured threshold, or the difference in RSRP associated with two measurement occasions is below a configured threshold. In some embodiments, the two measurement occasions described in the examples above may be associated with one or more beam IDs (e.g., DL-PRS beam IDs) and/or one or more TRP IDs. In some embodiments, the two measurement occasions described in the examples above may correspond to candidate measurements performed at two different measurement occasions (e.g., two different instances of time at which the WTRU (e.g., WTRU 204) receives sensing configuration information, such as a DL-PRS configuration). In some embodiments, the sensing configuration information (e.g., DL-PRS configuration) used for each candidate measurement includes a same ID or resource ID (e.g., DL-PRS resource ID). In other embodiments, the two candidate measurements may be performed using two different sensing configurations that include different IDs or different resource IDs (e.g., DL-PRS resource IDs).

Based on determining that the references (e.g., reference paths) are not the same, the WTRU may normalize the candidate measurements to change the reference of the candidate measurements. In one example, the WTRU receives a reference offset from the wireless network, indicating the offset between a reference from the wireless network and the reference measurement measured by the WTRU. The WTRU may determine to add the offset to the candidate measurement when comparing the two candidate measurements. For example, the WTRU may measure the relative delay with respect to a reference path. The WTRU may receive an offset between a path (e.g., LoS path) and the reference path and the WTRU may add this offset before making the comparisons between measurement occasions. In another example, the WTRU determines that the references (e.g., reference paths) between two candidate measurements are different and determines the candidate measurements to not be reference measurements, discards the candidate measurement, and/or reports the event to the wireless network by reporting invalid information of the candidate measurements.

In some embodiments, the WTRU determines that two candidate measurements do not meet the consistency conditions and discards one or both of the candidate measurements.

In some embodiments, the WTRU receives a measurement range. The WTRU may perform candidate measurements, determine candidate measurements to be reference measurements (e.g., apply measurement quality and/or consistency conditions), and/or report the reference measurements based on the measurement range. The measurement range may include at least one of the following indications: resource IDs (e.g., DL-PRS resource IDs), beam IDs (e.g., DL-PRS beam IDs), resource set IDs (e.g., DL-PRS resource set IDs), and/or TRP IDs, Path IDs (e.g., first path ID, set of path IDs, minimum path ID and maximum path ID), a minimum measurement and/or maximum measurement, a number of measurements(e.g., 5 measurements corresponding to 5 path measurements), or an indication of a measurement reference point.

In some embodiments, the measurement range includes a minimum measurement and/or maximum measurement. For example, the WTRU may receive an indication of a minimum AoA and/or a maximum AoA and may determine (e.g., only) candidate measurements within the minimum and maximum AoA to be reference measurements. In another example, the WTRU may receive an indication of a minimum and/or a maximum relative delay and may determine reference measurements based on the indicated relative delay range. In another example, the WTRU may receive a measurement range including an expected measurement value and a threshold. The WTRU may determine the range based on the expected measurement value and threshold. The expected measurement range may be one or more of candidate measurements corresponding to one measurement occasion, e.g., a previous measurement occasion (e.g., associated with a measurement occasion ID and/or measurement occasion timestamp).

In some embodiments, the measurement range includes an indication of a measurement reference point from the wireless network. The WTRU may use the indicated measurement reference point to perform (e.g., relative) candidate measurements in relation to the indicated measurement reference point. The indication of a measurement reference point may include one or more of the following: a reference path (e.g., a LoS path, a first path, a path ID), a reference TRP (e.g., in terms of cell ID, TRP ID, and/or sector ID), or a reference TRP ID, DL-PRS resource ID, DL-PRS beam ID, and/or DL-PRS resource set ID. In one example, the WTRU receives a measurement reference point for each candidate measurement associated with the indicated measurement reference point. In another example, the WTRU receives one measurement reference point associated with more than one candidate measurement.

In one example, the WTRU receives the indication of a measurement reference point within the indicated measurement range (e.g., AoA range). In another example, the WTRU, based on determining that the reference is out of the measurement range, performs one or more of the following actions: (1) determines to change the reference measurement point to a new reference measurement point within the measurement range, (2) performs the candidate measurement outside of the indicated measurement range, (3) determines the candidate measurement as invalid (e.g., determines that the candidate measurement is not to be used when determining a reference measurement), (4) discards the candidate measurement, or (5) reports the event to the wireless network.

In the examples described herein, a timestamp may be indicated by absolute time, relative time (e.g., in seconds) compared to a reference time, SFN, slot index, frame index, subframe index and/or symbol index. Some examples of “absolute time” may include UTC time, GNSS time, and locally-defined absolute time (e.g., LTE or NR Time).

### Measurement Procedure

In some embodiments, the WTRU receives an indication from the wireless network and/or determines to activate the reference measurement window based one or more conditions associated with activation of the reference measurement window. In one example, the WTRU activates the reference measurement window based on an indication from the wireless network. In another example, the WTRU activates the reference measurement window based on determining that one or more configured measuring conditions are satisfied. The WTRU may start the reference measurement window based on determining that the WTRU is positioned at an indicated location (e.g., area). The WTRU may additionally monitor (e.g., periodically) the RSs and measure SINR, RSRP, and/or RSSI of the resource. The WTRU may activate the reference measurement window based on determining that at least one of the candidate measurements are above a configured threshold. The WTRU may be configured to (e.g., only) perform the candidate measurements within the activated reference measurement window.

In some embodiments, the WTRU is configured to check one or more measuring conditions before performing candidate measurements, e.g., during or before one or more measurement occasions. The WTRU may subsequently perform candidate measurements based on determining that one or more measuring conditions are satisfied. In one example, the WTRU is configured to report one or more of the measuring conditions to the wireless network upon satisfaction of one or more measuring conditions and/or failure of one or more measuring condition. In another example, the WTRU receives sensing configuration information (e.g., DL-PRS configuration) for performing candidate measurements, which may include a resource configuration, a measurement configuration, one or more of the (e.g., configured) measuring conditions, and a reporting configuration from the wireless network. The WTRU may be configured with more than one set of resource configurations (e.g., DL-PRS resource configurations), each of which is associated with one or more measuring conditions. The WTRU may additionally be configured to activate the sensing configuration (e.g., DL-PRS configuration) based on the one or more measuring conditions.

In some embodiments, the WTRU is configured with one or more set of sensing configuration information (e.g., DL-PRS configurations) associated with one or more combinations of the measuring conditions. For example, the WTRU may be configured with and/or determine to activate a first resource configuration (e.g., DL-PRS resource configuration), which includes a first periodicity, based on determining that the WTRU is moving at a certain velocity, and activate a second resource configuration (e.g., DL-PRS resource configuration), which includes a second periodicity based on determining that the WTRU is moving at a different velocity. In another example, the WTRU is configured and/or determines to activate a first sensing configuration (e.g., DL-PRS configuration), which includes a first density (e.g., DL-PRS density) based on determining that the measured RSRP associated with a configured RS is above a configured threshold, and active a second sensing configuration (e.g., DL-PRS configuration), which includes a second density (e.g., DL-PRS density) based on determining that the measured RSRP is at or below the configured threshold. In another example, the WTRU is configured to perform one of a candidate measurement or relative delay measurement based on determining that the WTRU is in a particular area (e.g., coarse area, zone ID), and a different one of the candidate measurement or relative delay measurement based on determining that the WTRU is outside of the particular area. In another example, the WTRU is configured to perform one measurement (e.g., relative delay, candidate measurement) based on the WTRU determining that a time and/or phase synchronization error is above a configured threshold and perform another measurement (e.g., AoA, candidate measurement) based on the WTRU determining that the time and/or phase synchronization error is at or below the configured threshold. In other embodiments, based on determining that at least one of the measuring conditions are not satisfied, the WTRU determines to report the event and/or the associated candidate measurements to the wireless network.

In one example, the WTRU is configured to perform one or more candidate measurements (e.g., RSRP, RSRPP, AoA, phase, relative delay, doppler shift) from the received resources (e.g., DL-PRS resources) at one or more measurement occasions. The measurement occasions may correspond to one or more received resources (e.g., DL-PRS resources), one or more received beams (e.g., DL-PRS beams), one or more received resource sets (e.g., DL-PRS resource sets), and/or one or more TRPs.

In some embodiments, the WTRU is configured to perform the candidate measurements (e.g., only) within an indicated measurement range. In one example, the WTRU receives the measurement range in terms of at least one of the following: path IDs, resource IDs (e.g., DL-PRS resource IDs), beam IDs (e.g., DL-PRS beam IDs), resource set IDs (e.g., DL-PRS resource set IDs), TRP IDs, number of paths, minimum measurement indications, and/or maximum measurement indications.

In one example, the WTRU is configured to determine whether the reference measurement point (e.g., reference path) associated with one or more candidate measurements (e.g., relative candidate measurements) is within the measurement range. In another example, the WTRU is configured to report and/or terminate the measurement procedure based on determining that the reference measurement point is not within the measurement range. In another example, the WTRU is configured to measure the reference measurement point determined to be outside the indicated measurement range. The WTRU may report to the wireless network that the measured reference measurement point is not within the measurement range.

In another example, the WTRU receives an indication and/or is configured to determine a new measurement range at a new measurement occasion. The new measurement range may be a relative range (e.g., with respect to a measurement range corresponding to one of the previous measurement occasions). The WTRU may update the measurement range to be the determined new measurement range for the new measurement occasion.

In some embodiments, the WTRU is configured to determine that a candidate measurement may be used to determine a reference measurement based on determining that the candidate measurement is a valid measurement. The WTRU may determine a candidate measurement to be a valid measurement based on determining that the candidate measurement satisfies one or more combinations of the reference measurement conditions (e.g., measuring conditions, quality conditions and consistency conditions). For example, the WTRU may be configured with measurement thresholds. The WTRU may determine a candidate measurement (e.g., RSRPP, doppler shift) to be a valid measurement based on determining that the candidate measurement is above or below the configured threshold. For example, the WTRU may be configured with measurement thresholds. The WTRU may determine a candidate measurement (e.g., RSRPP, doppler shift) to be a valid measurement based on determining that the candidate measurement is above or below the configured threshold.

In one example, the WTRU considers a candidate measurement to be a valid measurement (e.g., based on measurement quality) based on determining that the candidate measurement satisfies the received measuring conditions and/or the candidate measurement corresponds to the received measurement range.

In some embodiments, when the WTRU determines that one candidate measurement (e.g., corresponding to one path) does not satisfy the quality conditions, the WTRU invalidates only that candidate measurement, e.g., in that respective measurement occasion. In another embodiment, the WTRU may invalidate all of the candidate measurements associated with a measurement occasion based on determining that one candidate measurement of the measurement occasion does not satisfy the quality conditions. For example, the WTRU may invalidate all of the candidate measurements associated with a measurement occasion based on determining that the candidate measurement (e.g., RSRPP) of a single path (e.g., reference path) is below the configured threshold. In some examples, the WTRU determines a candidate measurement to be invalid, discards the candidate measurement, and/or reports the event and/or candidate measurement to the wireless network based on determining that at least one of the quality conditions are not satisfied.

In some embodiments, the WTRU determines a candidate measurement to be used to determine a reference measurement based on determining that the candidate measurement is consistent. The WTRU may determine a candidate measurement to be consistent based on determining that the candidate measurement satisfies one or more received consistency conditions.

In one example, the WTRU determines whether two candidate measurements are consistent, where the two candidate measurements may correspond to different paths, measurement occasions, resourced (e.g., DL-PRS resources), beams (e.g., DL-PRS beams), resource IDs (e.g., DL-PRS resource IDs), and/or TRPs. In another example, the WTRU is configured with a reference measurement threshold indicating the consistency between candidate measurements (e.g., relative candidate measurements) based on candidate measurements of one or more measurement reference points. In another example, the WTRU is configured with a threshold for measurement difference, where the candidate measurements correspond to measurements of the reference measurement point (e.g., reference path).

In one example, the WTRU determines a candidate measurement to be inconsistent if the reference measurement point is not measured in one measurement occasion (e.g., for a reference measurement point within the indicated measurement range). In another example, the WTRU determines that a candidate measurement is consistent based on channel measurement conditions. The WTRU may determine channel measurements, e.g., from one or more of the configured RSs (e.g., while determining measuring conditions), and receive a channel measurement difference threshold. The WTRU may determine a candidate measurement of a respective path to be consistent based on a comparison of candidate measurements of the respective paths performed at one or more measurement occasions and determining that a different between the one or more channel measurements are above or below the channel measurement difference threshold. In one example, the WTRU determines that a candidate measurement is inconsistent, discards the candidate measurement and/or reports the event and/or candidate measurement to the wireless network based on determining that at least one of the consistency conditions are not satisfied.

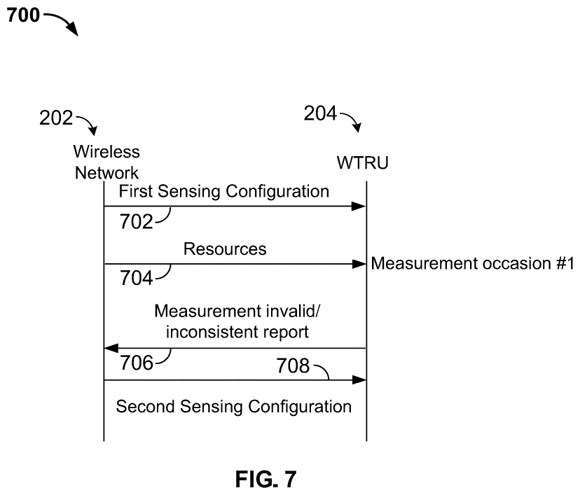

FIG. 7 is an illustrative example 700 of the WTRU 204 performing a candidate measurement with a resource 704 (e.g., DL-PRS resource) and a first sensing configuration 702 (e.g., DL-PRS configuration), reporting invalid information 706 of one or more candidate measurements (e.g., an invalid and/or inconsistent measurement) to the wireless network 202, and subsequently activating a second sensing configuration 708 (e.g., updated DL-PRS configuration) received from the wireless network 202.

As shown in FIG. 7, in some embodiments, the WTRU 204 receives a first configuration 702 (e.g., DL-PRS configuration) that includes any one or more of a resource configuration, a measurement configuration, and a reporting configuration from the wireless network 202. The WTRU 204 also receives and activates the configured resources 704 (e.g., DL-PRS resources) for performing candidate measurements (e.g., a candidate measurement performed at a measurement occasion.

The WTRU 204 may activate a first resource of the resource 704s (e.g., DL-PRS resources) based on determining that a difference of candidate measurements (e.g., of LoS path, reference path, k-th path) between two measurement occasions is below a configured threshold or activate a second resource of the resources 704 (e.g., DL-PRS resources) based on determining that the difference is at or above the threshold. The WTRU 204 may be configured with and/or may determine to activate first sensing configuration 702 (e.g., DL-PRS configuration) based on determining that the candidate measurements are valid (e.g., satisfying one or more of the quality conditions) and/or that the candidate measurement are consistent (e.g., satisfying one or more of the consistency conditions). In some embodiments, the WTRU 204 may determine to activate second sensing configuration 708 (e.g., DL-PRS configuration) based on determining that the candidate measurements are invalid (e.g., not satisfying one or more of the quality conditions) and/or that the candidate measurement are in consistent (e.g., not satisfying one or more of the consistency conditions).

As illustrated in FIG. 7, in one example, the WTRU 204 receives second configuration 708 (e.g., DL-PRS configuration) or an indication to activate second sensing configuration 708 (e.g., DL-PRS configuration) from the wireless network 202 based on the WTRU 204 sending a report 706 of invalid information of candidate measurements (e.g., a measurement invalidity or inconsistency report) to the wireless network 202.

### Reference Measurement Determination

The WTRU may be configured to determine a reference measurement based on one or more candidate measurements performed within the reference measurement window. In some embodiments, each of the candidate measurements may correspond to one or more paths, one or more resource (e.g., DL-PRS resource), one or more resource set (e.g., DL-PRS resource sets), and/or one or more TRP(s).

The WTRU then determines at least one reference measurement based on the candidate measurements and based on at least one reference measurement condition. In some embodiments, the reference measurement conditions include: (1) that the candidate measurements are performed within the reference measurement window, (2) that the WTRU satisfied at least one of the configured measuring conditions during the measurement occasion of the candidate measurements, (3) that the candidate measurements performed within at least one of an indicated measurement range, (4) that the candidate measurements satisfy at least one of the quality conditions, or (5) that the candidate measurements satisfy at least one of the consistency conditions.

In some embodiments, the WTRU may perform a respective set of candidate measurements for each respective path, PRS resource ID, PRS beam, PRS resource set, PRS beam, and/or TRP. In some embodiments, the WTRU may be configured to determine and/or report reference measurements based on at least one of the following reference measurement conditions: (1) a total number of candidate measurements is greater than a configured threshold based on the configuration received from the wireless network, (2) a total number of candidate measurements associated with a respective path, a respective one or pair of DL-PRS beams, or a respective one or a pair of TRPs is above a configured threshold based on the configuration, (3) a total number of (e.g., consecutive) candidate measurements satisfying one or more of the measuring conditions is above a configured threshold, (4) a total number of (e.g., consecutive) candidate measurements that do not satisfy one or more of the measuring conditions is less than a configured threshold, (5) a total number of (e.g., consecutive) candidate measurements satisfying one or more of the quality conditions is greater than a configured threshold, (6) a total number of (e.g., consecutive) candidate measurements not satisfying one or more of the quality conditions is less than a configured threshold, (7) a total number of (e.g., consecutive) candidate measurements satisfying one or more of the consistency conditions is greater than a configured threshold, (8) a total number of (e.g., consecutive) candidate measurements not satisfying one or more of the consistency conditions is less than a configured threshold.

In some embodiments, if the WTRU determines that a candidate measurement does not satisfy one or more of the reference measurement conditions, the WTRU does not use the candidate measurement to determine the reference measurement based on one or more of the conditions mentioned above not being satisfied. Alternatively, the WTRU may be configured to report the event (e.g., that the WTRU was unable to determine the reference measurement) and the cause of the event to the wireless network.

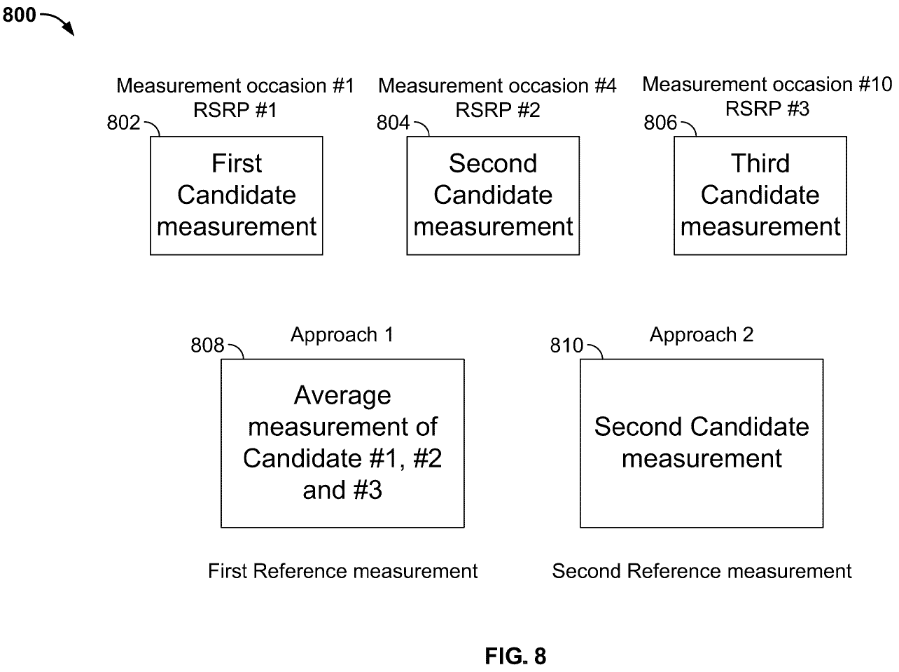

FIG. 8 shows an illustrative example 800 of two approaches for determining reference measurements, a first approach 808 based on averaging multiple candidate measurements (e.g., candidate measurement #1 802, candidate measurement #2 804, and candidate measurement #3 806) and a second approach 810 based on selecting a candidate measurement (e.g., candidate measurement #2 804).

In some embodiments, the WTRU (e.g., WTRU 204) may average the reference measurements determined during the configured reference measurement window. The WTRU (e.g., WTRU 204) may indicate to the wireless network (e.g., wireless network 202) that the reported reference measurement is the average reference measurement made during the reference measurement window.

As shown in FIG. 8, in some embodiments, the WTRU (e.g., WTRU 204) determines a reference measurement from a set of candidate measurements based on an average of candidate measurements 808. In one example, the WTRU determines a reference measurement based on an average (e.g., mean, median, or mode) of the one or more candidate measurements, e.g., corresponding to one or more measurement occasions. In one example, the WTRU may determine that at least one of the following common properties or candidate measurements be below a respective threshold for averaging two candidate measurements: path measurements (e.g., AoA measurements, relative delay measurements) such that if the candidate measurements correspond to the resource (e.g., DL-PRS resources) from one TRP, matching beams (e.g., DL-PRS beams) and/or pair of beams (e.g., DL-PRS beams), matching resource sets (e.g., DL-PRS resource sets), or matching TRPs and/or pair of TRPs. For example, the WTRU determines that reference measurement to be an average of first candidate measurement 802, second candidate measurement 804, and third candidate measurement 806, as depicted in the first approach 808 of FIG. 8.

In one example, the WTRU does not determine the candidate measurements to be reference measurements based on one or more of the conditions mentions above. In this example, the WTRU may be configured to report the event (e.g., inability to determine reference measurement) and the cause of the event to the wireless network.

As illustrated in FIG. 8, in other embodiments, the WTRU determines the reference measurement to be one or more of the candidate measurements. In one example, the WTRU determines and/or reports one or more of the candidate measurements as a reference measurement based on at least one of the following conditions: (1) the candidate measurement corresponds to the measurement occasion (e.g., among the measurement occasions corresponding to candidate measurements) with one or more measurements (e.g., RSRP or RSRPP of LoS path or reference path) above or below a configured threshold, (2) the candidate measurement corresponds to the measurement occasion with a measurement of the measurement reference point (e.g., reference path) above a configured threshold, (3) the candidate measurement corresponds to the measurement occasion with an uncertainty below a configured threshold, (4) the candidate measurement corresponds to the measurement occasion with a number of measured multipaths components below a configured threshold, or (5) the candidate measurement corresponds to the measurement occasion with channel measurements(e.g., delay spread, doppler spread) below a configured threshold.

For example, the WTRU may determine the reference measurement to be second candidate measurement 804 based on determining that the RSRP of the resource (e.g., PRS resource) of the corresponding measurement occasion (e.g., measurement occasion #4) is the highest of the measurement occasions corresponding to candidate measurements and/or is above a configured threshold.

The WTRU (e.g., WTRU 204) is configured to report the reference measurement to the wireless network (e.g., wireless network 202). In some embodiments, the WTRU (e.g., WTRU 204) may indicate to the wireless network (e.g., wireless network 202) whether the reported reference measurement is: (1) one of the candidate measurements or (2) an average of the candidate measurements.

### Validity Duration Determination

In some embodiments, the WTRU determines a validity duration associated with one or more of the reference measurements. The WTRU may determine the validity duration for the reference measurements based on one or more of the following factors: (1) a number of candidate measurements associated with the reference measurements, (2) a statistical measure (e.g., average, variance) of candidate measurements (e.g., RSRP, RSRPP of a path, reference path) associated with the reference measurements, (3) a number of samples of the candidate measurements associated with the reference measurements, (4) an uncertainty of the candidate measurements associated with the reference measurements, (5) a resolution of the candidate measurements associated with the reference measurements, (6) a statistical measure (e.g., average, variance) of channel measurements (e.g., RSRP, RSRQ, SINR) of the measurement occasions associated with the candidate measurements associated with the reference measurements, (7) a configured DL-PRS bandwidth, (8) an WTRU antenna array (e.g., for AoA measurement), (9) a center frequency (e.g., for phase measurements), or (10) the WTRU is configured, by the wireless network (e.g., gNB, LMF), with the validity duration.

The WTRU may determine the validity duration for the reference measurements independently or jointly with one or more reference measurements. For example, the WTRU may determine the validity duration per-path, per-group of paths, per-DL-PRS resource, per-DL-PRS beam, per-DL-PRS resource sets, and/or per-TRP.

In some embodiments, the WTRU may be configured, by the wireless network, with a mapping table that the WTRU uses to determine validity duration. In such embodiments, the mapping table may include mappings, each mapping associating one or more of the aforementioned factors (e.g., the number of candidate measurements associated with the reference measurement) with a validity duration.

The WTRU may determine and/or report the validity duration for each path associated with one or more measurement occasions.

### Measurement Reporting

In some embodiments, the WTRU is configured to report the one or more reference measurements based on determining that one or more of the following conditions are satisfied: (1) one or more of the measuring conditions, quality conditions, and/or consistency conditions are satisfied when determining the reference measurements, (2) one or more of the determined reference measurements corresponds to the indicated measurement range, (3) the number of (e.g., consecutive) measurements (e.g., reference measurements) satisfying the measuring conditions, quality conditions, and/or consistency conditions is above a configured threshold, (4) the number of candidate measurements associated with determination of the reference measurements is above a configured threshold, (5) the determined validity duration of the reference measurements is above a configured threshold, or (6) the reference measurement window has expired.

For each reference measurement, the WTRU may report at least one of the following: (1) one or more measurement identifier(s) associated with the one or more reported measurements (e.g., path IDs, DL-PRS resource IDs, DL-PRS resource set IDs, measurement occasion IDs), (2) measurement definition criteria, e.g., path, PRS resource, PRS Beam, PRS Resource set, TRP, cell, criteria, (3) measurements (e.g., reference measurements, candidate measurements associated with the reference measurements, measurements not determined to be candidate measurements), (4) associated RSs (e.g., associated with one or more reference measurements, candidate measurements associated with reference measurements, and/or measurements not qualified as candidate measurements), (5) validity duration associated with the reference measurements, (6) the satisfied measuring conditions, quality conditions, and/or consistency conditions (e.g., associated with reference measurements, candidate measurements associated with reference measurements, and/or measurements not qualified as candidate measurements), (7) indications if the measurement is a reference measurement (e.g., with averaging, without averaging), candidate measurement, measurement not associated as candidate measurements, measurement performed in a certain measurement occasion, (8) measuring conditions associated with one or more measurements or measurement occasions, (9) indications of one or more satisfied measuring conditions, or (10) timestamps associated with the measurements (e.g., associated with reference measurements, candidate measurements associated with reference measurements, and/or measurements not qualified as candidate measurements).

The measurements (e.g., reference measurements, candidate measurements) reported by the WTRU may include one or more of the following: one or more RSRPP measurements, one or more AoA (e.g., per path) measurements, one or more relative phase measurements, one or more delay spread measurements, one or more doppler shift (e.g., per-path) measurements, one or more doppler spread measurements, or one or more channel measurements (e.g., RSRP, RSRQ, RSSI).

The associated RSs reported by the WTRU may include one or more of the following: DL-PRS resource IDs, DL-PRS resource IDs, DL-PRS resource set IDs, TRP IDs, and/or cell IDs associated with measurements, an association between different beams of the DL-RSs, e.g., DL-PRS beam ID #1 and DL-PRS beam ID #2, or an association between DL-RSs and UL-RSs, e.g., an association between DL-PRS and SRSp, an association between DL-PRS beam ID #1 and SRSp beam ID #1. In some examples, the association is a quasi-colocation (QCL) association.

In some embodiments, the WTRU terminates the procedure for reference measurement based on at least one of the following conditions: (1) the WTRU determines expiration of the reference measurement window, (2) the WTRU determines successful reporting of the reference measurement to the wireless network, (3) the WTRU receives an indication from the wireless network to terminate the reference measurement procedure, or (4) the WTRU determines one or more conditions for determining and/or reporting reference measurements are not satisfied.

In some embodiments, the WTRU may be configured to use the determined reference measurements for sensing. In some embodiments, the WTRU may be configured to process any candidate measurements (e.g., corresponding to different measurement occasions) based on determined the reference measurements. For example, the WTRU may process candidate measurements by performing manipulations (e.g., additions, subtractions, multiplications, division, appending, or eliminating) of one or more components of the candidate measurements.

In some embodiments, a candidate measurement and a reference measurement may be processed simultaneously if the candidate measurement and the reference measurement correspond to at least one of the same: (a) path, (b) resource (e.g., PRS resource), resource set (e.g., PRS resource set), beam (e.g., PRS beam), TRP, or reference associated with the candidate measurement.

For example, the WTRU may determine to process (e.g., remove any effect of) reference measurements in a new candidate measurement in order to determine a comparative change in the candidate measurements. In some embodiments, the WTRU may be configured to report the processed candidate measurements based on the reference measurement. In one example, processing phase measurements may include subtracting a reference phase measurement of a path from the phase measurement for the same path at a different measurement occasion.

In some embodiments, the WTRU may be configured to report at least one of the following that correspond to a candidate measurement of a reference measurement and the candidate measurement at a different measurement occasion: (1) candidate measurements of at least one of reference measurements and/or the candidate measurements, references associated with at least one of reference measurements and/or the candidate measurements, and (3) a difference between the candidate measurements and reference measurements.

In some embodiments, the WTRU may be configured to report the reference measurement when the difference between the candidate measurement and reference measurement is above a configured threshold.

In other embodiments, the WTRU may be configured to perform candidate measurements (e.g., in a new measurement occasion) based on the reference measurements. For example, the WTRU may be configured to perform the candidate measurements after the validity duration of one or more of the reference measurements have elapsed. Furthermore, the WTRU may determine to perform candidate measurements and/or reporting reference measurements after the validity duration of one or more reference measurements have elapsed.

The WTRU may be configured with or may determine the sensing configuration information (e.g., DL-PRS configuration) for performing candidate measurements based on the reference measurements. For example, the WTRU may be configured to perform candidate measurements and/or reporting reference measurements with a periodicity when at least one of the candidate measurements or when by comparing an associated statistic (e.g., variance) of the candidate measurements to a configured threshold (e.g., the associated statistic is above or below the configured threshold).

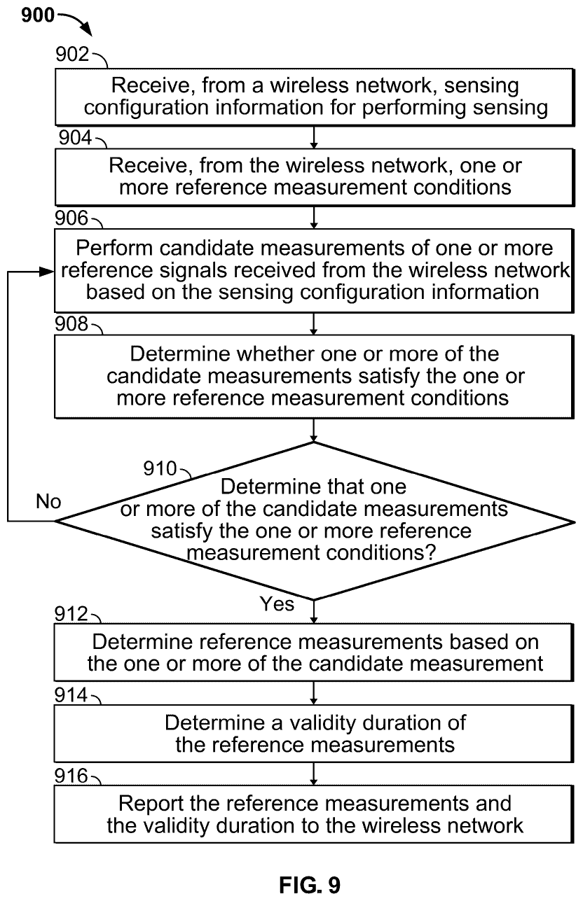

FIG. 9 shows a flowchart of an illustrative process 900 for sensing and determining reference measurements performed by a WTRU (e.g., WTRU 204, WTRUs 102a, 102b, 102c, 102d), which may be implemented in communications system 100 illustrated in FIG. 1A-1D.

At 902, the WTRU (e.g., WTRU 204) receives, from a wireless network, sensing configuration information (e.g., a DL-PRS configuration) for performing sensing. The WTRU may receive sensing configurations corresponding to one or more measurement occasions and the sensing configurations may include periodic or semi-static resources (e.g., DL-PRS resources) to perform candidate measurements. In some embodiments, the WTRU receives sensing configuration information in response to the WTRU requesting, from the wireless network, sensing configuration information for performing candidate measurements (e.g., based on one or more trigger conditions) or the WTRU reporting capability information (e.g., via a semi-static message or a dynamic message).

At 904, the WTRU receives, from the wireless network, one or more reference measurement conditions. The received reference measurement conditions may include one or more of measuring conditions (e.g., WTRU location, WTRU orientation, the reference measurement window, or the measurement range), quality conditions (e.g., measurement thresholds, measurement uncertainty thresholds, number of measurement samples), or consistency conditions (e.g., measurement difference thresholds, reference measurement thresholds, channel measurement difference thresholds).

At 906, the WTRU performs candidate measurements of one or more reference signals received from the wireless network based on the sensing configuration information (e.g., DL-PRS configuration). In some embodiments, the WTRU performs candidate measurements based additionally on the reference measurement conditions (e.g., activated reference measurement window, identified reference measurement point outside of measurement range). Candidate measurements may include one or more of RSRPP, AoA (e.g., per-path), relative phase, delay spread, doppler shift (e.g., per-path), doppler spread, or channel measurements (e.g., RSRP, RSRQ, RSSI). In some embodiments, each of the candidate measurements may correspond to one or more paths, one or more DL-PRS resource, one or more DL-PRS resource sets, and/or one or more TRPs.

At 908, the WTRU determines whether one or more of the candidate measurements satisfy the one or more reference measurement conditions. In some embodiments, the WTRU only determines whether a candidate measurement satisfies the quality conditions based on determining that the candidate measurement satisfies the measuring conditions and/or the candidate measurement corresponds to the configured measurement range. In one example, the WTRU determines that a candidate measurement that does not satisfy one consistency condition does not satisfy the reference measurement conditions even though it was performed within the reference measurement window and satisfies the quality conditions. In another example, the WTRU may only determine a reference measurement based on a total number of candidate measurements that satisfy the reference measurement conditions exceeding a threshold.

At 910, when the WTRU determines that the one or more of the candidate measurements satisfy the one or more reference measurement conditions the process 900 proceeds to determine reference measurements based on the one or more of the candidate measurements, at 912. When the WTRU determines that the one or more of the candidate measurements do not satisfy the one or more reference measurement conditions the process 900 proceeds to perform candidate measurements of one or more reference signals received from the wireless network based on the sensing configuration information, at 906. In some embodiments, the WTRU additionally discards the candidate measurements or reports the event and/or candidate measurements to the wireless network upon the determination that the one or more of the candidate measurements do not satisfy the one or more reference measurement conditions.

At 912, the WTRU determines reference measurements based on the one or more of the candidate measurements. In some embodiments, the WTRU determines a reference measurement from a set of candidate measurements based on an average (e.g., mean, median, or mode) of candidate measurements. In other embodiments, the WTRU determines the reference measurement to be one or more of the candidate measurements, e.g., based on the corresponding measurement occasion including one or more measurements, measurement reference points, uncertainties, number of multipath components, and/or channel measurements above or below a configured threshold.

At 914, the WTRU determines a validity duration of the reference measurements determined at 912. In some embodiments the validity duration is associated with the reference measurements determined at 912, where the validity duration is based on one or more of a quantity, statistical measure, number of samples, uncertainty, or resolution of the candidate measurements associated with the reference measurements. The validity duration may also be based on a statistical measure of the channel measurements (e.g., RSRP, RSRQ, SINR) of the measurement occasions associated with the candidate measurements associated with the reference measurements, a configured DL-PRS bandwidth, a WTRU antenna array, and/or a center frequency (e.g., for phase measurements). The WTRU may determine the validity duration for the reference measurements independently or jointly with one or more reference measurements. For example, the WTRU may determine the validity duration per-path, per-group of paths, per-DL-PRS resource, per-DL-PRS beam, per-DL-PRS resource sets, and/or per-TRP.

At 916, the WTRU reports the reference measurements and the validity duration to the wireless network. The WTRU may report the reference measurements and the validity duration based on determining that one or more conditions have been satisfied (e.g., one or more reference measurements have been determined, the number of candidate measurements associated with determination of the reference measurements exceed a configured threshold, the validity duration determined at 914 exceeds a configured threshold, the reference measurement window has expired). In some embodiments, the WTRU reference measurements report includes one or more of measurement definition criteria (e.g., path, PRS resource, PRS Beam, PRS Resource set, TRP, cell, criteria), associated RSs, indications of the type of measurement (e.g., reference, candidate, not a candidate), measuring conditions, and/or timestamps associated with the reference measurements).

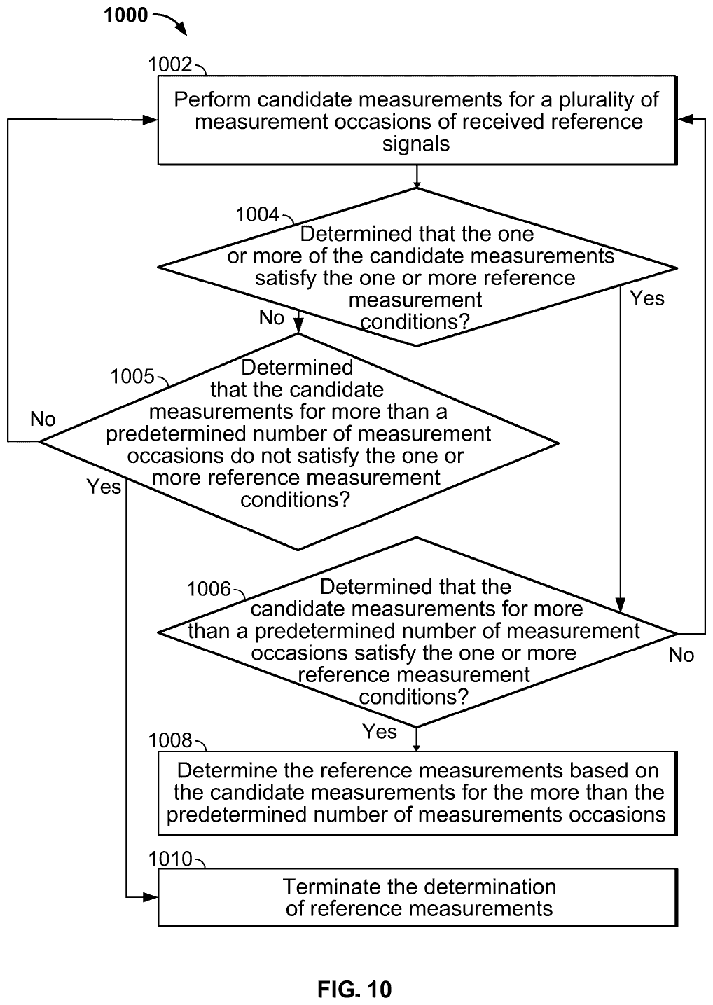

FIG. 10 shows a flowchart of an illustrative subprocess 1000 for terminating the determination of reference measurements performed by a WTRU (e.g., WTRU 204, WTRUs 102a, 102b, 102c, 102d), which may be implemented in communications system 100 illustrated in FIG. 1A-1D.

At 1002, the WTRU performs candidate measurements for a plurality of measurement occasions of received reference signals. In some embodiments, the WTRU performs candidate measurements for a plurality of measurement occasions of received reference signals as a part of performing candidate measurements of one or more reference signals received from the wireless network based on the sensing configuration information (e.g., DL-PRS configuration), at 906 of process 900.

At 1004, the WTRU determines whether the one or more of the candidate measurements satisfy the one or more reference measurement conditions (e.g., measuring conditions, quality conditions, consistency conditions). When the WTRU determines that the one or more of the candidate measurements satisfy the one or more reference measurement conditions, subprocess 1000 proceeds to determine whether the candidate measurements for more than a predetermined number of measurement occasions satisfy the one or more reference measurement conditions, at 1006. When the WTRU determines that the one or more of the candidate measurements do not satisfy the one or more reference measurement conditions, subprocess 1000 proceeds to determine whether the candidate measurements for more than a predetermined number of measurement occasions do not satisfy the one or more reference measurement conditions at 1005.

At 1005, the WTRU determines whether the candidate measurements for more than a predetermined number of measurement occasions do not satisfy the one or more reference measurement conditions (e.g., measuring conditions, quality conditions, consistency conditions). In some embodiments, a counter may be used by the WTRU at 1005, such the counter increments a counter value for each determined candidate measurement that does not satisfy the one or more reference measurement conditions at 1004. In such embodiments, the counter value may be compared to the predetermined number of measurement occasions. When the WTRU determines that the candidate measurements for more than the predetermined number of measurement occasions do not satisfy the one or more reference measurement condition, subprocess 1000 proceeds to terminate the determination of reference measurements at 1010. When the WTRU determines that the candidate measurements that do not satisfy the one or more reference measurement conditions are not more than the predetermined number of measurement occasions, subprocess 1000 proceeds to perform candidate measurements for a plurality of measurement occasions of received reference signals at 1002.

At 1006, the WTRU determines whether the candidate measurements for more than a predetermined number of measurement occasions satisfy the one or more reference measurement conditions. In some embodiments, a counter may be used by the WTRU at 1006, such the counter increments a counter value for each determined candidate measurement that satisfies the one or more reference measurement conditions at 1004. In such embodiments, the counter value may be compared to the predetermined number of measurement occasions. When the WTRU determines that the candidate measurements for more than the predetermined number of measurement occasions satisfy the one or more reference measurement conditions subprocess 1000 proceeds to determine the reference measurements based on the candidate measurements for the more than the predetermined number of measurement occasions at 1008. When the WTRU determines that the candidate measurements that do satisfy the one or more reference measurement conditions are not more than the predetermined number of measurement occasions, subprocess 1000 proceeds to perform candidate measurements for a plurality of measurement occasions of received reference signals at 1002.

At 1008, the WTRU determines the reference measurements based on the candidate measurements for the more than the predetermined number of measurement occasions. In some embodiments, the WTRU takes an average (e.g., mean, median, mode) of the candidate measurements, and in other embodiments, the WTRU determines one or more of the candidate measurements to be the reference measurements.

At 1010, the WTRU terminates the determination of reference measurements. The WTRU may stop performing candidate measurements and/or determining reference measurement from the candidate measurements. In some embodiments, the WTRU sends a report of the event (e.g., termination of the reference measurement procedure, failure to determine reference measurement) and/or the candidate measurements to the wireless network.

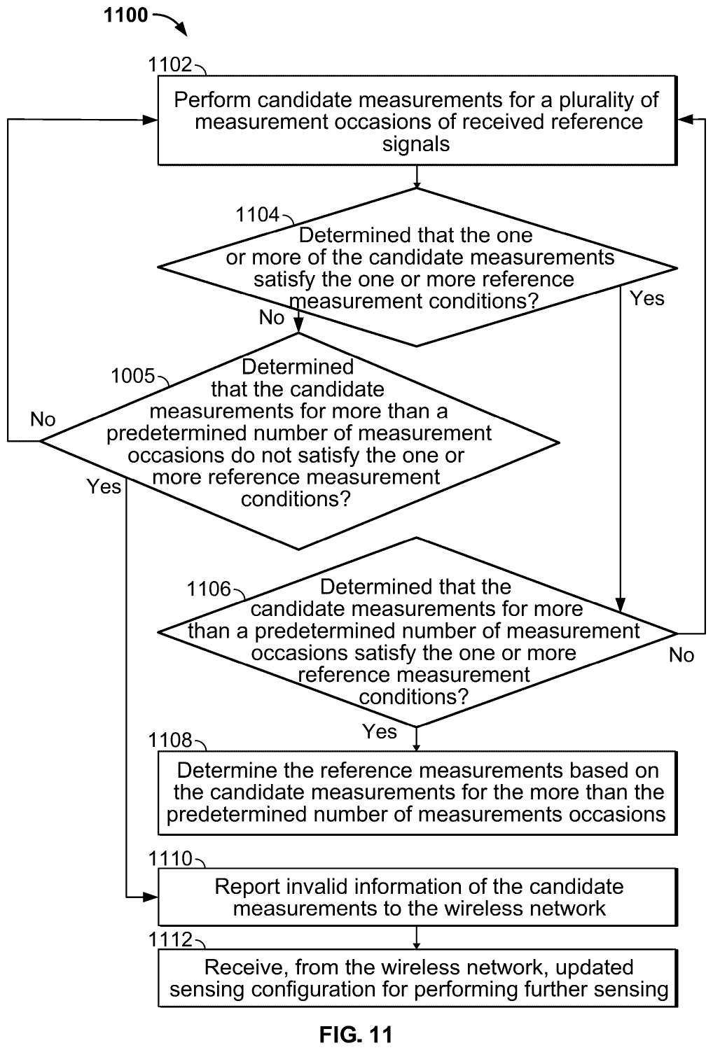

FIG. 11 shows a flowchart of an illustrative subprocess 1100 for reporting invalid information of candidate measurements performed by a WTRU (e.g., WTRU 204, WTRUs 102a, 102b, 102c, 102d), which may be implemented in communications system 100 illustrated in FIG. 1A-1D.

At 1102, the WTRU performs candidate measurements for a plurality of measurement occasions of received reference signals. In some embodiments, the WTRU performs candidate measurements for a plurality of measurement occasions of received reference signals as a part of performing candidate measurements of one or more reference signals received from the wireless network based on the sensing configuration information (e.g., DL-PRS configuration), at 906 of process 900.

At 1104, the WTRU determines whether the one or more of the candidate measurements satisfy the one or more reference measurement conditions (e.g., measuring conditions, quality conditions, consistency conditions). When the WTRU determines that the one or more of the candidate measurements satisfy the one or more reference measurement conditions, subprocess 1100 proceeds to determine whether the candidate measurements for more than a predetermined number of measurement occasions satisfy the one or more reference measurement conditions, at 1106. When the WTRU determines that the one or more of the candidate measurements do not satisfy the one or more reference measurement conditions, subprocess 1100 proceeds to determine whether the candidate measurements for more than a predetermined number of measurement occasions do not satisfy the one or more reference measurement conditions at 1105.

At 1105, the WTRU determines whether the candidate measurements for more than a predetermined number of measurement occasions do not satisfy the one or more reference measurement conditions (e.g., measuring conditions, quality conditions, consistency conditions). In some embodiments, a counter may be used by the WTRU at 1105, such the counter increments a counter value for each determined candidate measurement that does not satisfy the one or more reference measurement conditions at 1104. In such embodiments, the counter value may be compared to the predetermined number of measurement occasions. When the WTRU determines that the candidate measurements for more than the predetermined number of measurement occasions do not satisfy the one or more reference measurement condition, subprocess 1100 proceeds to report invalid information of the candidate measurements to the wireless network at 1110. When the WTRU determines that the candidate measurements that do not satisfy the one or more reference measurement conditions are not more than the predetermined number of measurement occasions, subprocess 1100 proceeds to perform candidate measurements for a plurality of measurement occasions of received reference signals at 1102.

At 1106, the WTRU determines whether the candidate measurements for more than a predetermined number of measurement occasions satisfy the one or more reference measurement conditions. In some embodiments, a counter may be used by the WTRU at 1106, such the counter increments a counter value for each determined candidate measurement that satisfies the one or more reference measurement conditions at 1104. In such embodiments, the counter value may be compared to the predetermined number of measurement occasions. When the WTRU determines that the candidate measurements for more than the predetermined number of measurement occasions satisfy the one or more reference measurement conditions subprocess 1100 proceeds to determine the reference measurements based on the candidate measurements for the more than the predetermined number of measurement occasions at 1108. When the WTRU determines that the candidate measurements that do satisfy the one or more reference measurement conditions are not more than the predetermined number of measurement occasions, subprocess 1100 proceeds to perform candidate measurements for a plurality of measurement occasions of received reference signals at 1102.

At 1108, the WTRU determines the reference measurements based on the candidate measurements for the more than the predetermined number of measurement occasions. In some embodiments, the WTRU takes an average (e.g., mean, median, mode) of the candidate measurements, and in other embodiments, the WTRU determines one or more of the candidate measurements to be the reference measurements.

At 1110, the WTRU reports invalid information of the candidate measurements to the wireless network. In some embodiments, the invalid information includes candidate measurements which did not satisfy the one or more reference measurement conditions, (e.g., measuring conditions, quality conditions, or consistency conditions). In some embodiments, the report that includes invalid information of the candidate measurements may be the measurement invalidity or inconsistency report.

At 1112, the WTRU receives, from the wireless network, updated sensing configuration information (e.g., updated DL-PRS configuration) for performing further sensing. In some embodiments, the WTRU receives, from the wireless network, the updated sensing configuration information in response to the wireless receiving the report of invalid information of candidate measurements (e.g., measurement invalidity or inconsistency report).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU), (ii) any of a number of embodiments of a WTRU, (iii) a wireless-capable and/or wired-capable (e.g., tetherable) device configured with, inter alia, some or all structures and functionality of a WTRU, (iii) a wireless-capable and/or wired-capable device configured with less than all structures and functionality of a WTRU, or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, or methods described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving, from a wireless network, sensing configuration information for performing sensing;
receiving, from the wireless network, one or more reference measurement conditions;
performing candidate measurements of one or more reference signals received from the wireless network based on the sensing configuration information;
determining whether one or more of the candidate measurements satisfy the one or more reference measurement conditions; and
in response to determining that the one or more of the candidate measurements satisfy the one or more reference measurement conditions:
determining reference measurements based on the one or more of the candidate measurements;
determining a validity duration of the reference measurements; and
reporting the reference measurements and the validity duration to the wireless network.

2. The method of claim 1, wherein performing the candidate measurements of the one or more reference signals comprises performing the candidate measurements of one or more reference signals during a reference measurement window.

3. The method of claim 1, wherein determining the validity duration of the reference measurements is based on a number of the one or more of the candidate measurements and an uncertainty of each of the number of the one or more candidate measurements.

4. The method of claim 1, wherein the one or more reference measurement conditions comprises one or more of a measuring condition, a quality condition, or a consistency condition, and wherein determining whether the one or more candidate measurements satisfy the one or more reference measurement conditions comprises:
determining whether the measuring condition is satisfied;
determining whether the quality condition is satisfied; or
determining whether the consistency condition is satisfied.

5. The method of claim 4, wherein determining whether the measuring condition is satisfied comprises determining whether the WTRU is located in a configured measurement area.

6. The method of claim 4, wherein determining whether the quality condition is satisfied comprises determining whether a quality measurement of the one or more candidate measurements is greater than a threshold of the quality condition.

7. The method of claim 4, wherein determining whether the consistency condition is satisfied comprises determining whether a difference between two candidate measurements on two occasions is less than a threshold of the consistency condition.

8. The method of claim 1, wherein:
performing the candidate measurements of the one or more reference signals comprises performing the candidate measurements for a plurality of measurement occasions of received reference signals; and
determining whether the one or more of the candidate measurements satisfy the one or more reference measurement conditions comprises:
determining whether the candidate measurements for more than a predetermined number of measurement occasions satisfy the one or more reference measurement conditions; and
in response to determining that the one or more reference measurement conditions are satisfied for more than the predetermined number of measurement occasions:
determining the reference measurements based on the candidate measurements for the more than the predetermined number of measurements occasions.

9. The method of claim 1, wherein:
performing the candidate measurements of the one or more reference signals comprises performing the candidate measurements for a plurality of measurement occasions of received reference signals; and
determining whether the one or more of the candidate measurements satisfy the one or more reference measurement conditions comprises:
determining whether the candidate measurements for more than a predetermined number of measurement occasions satisfy the one or more reference measurement conditions; and
in response to determining that the one or more reference measurement conditions are not satisfied for more than the predetermined number of measurement occasions:
terminating the determination of reference measurements.

10. The method of claim 1, wherein:
performing the candidate measurements of the one or more reference signals comprises performing the candidate measurements for a plurality of measurement occasions of received reference signals; and
determining whether the one or more of the candidate measurements satisfy the one or more reference measurement conditions comprises:
determining whether the candidate measurements for more than a predetermined number of measurement occasions satisfy the one or more reference measurement conditions; and
in response to determining that the one or more reference measurement conditions are not satisfied for more than the predetermined number of measurement occasions:
reporting invalid information of the candidate measurements to the wireless network; and
receiving, from the wireless network, updated sensing configuration information for performing further sensing.

11. A wireless transmit/receive unit (WTRU), comprising:
a processor; and
a transceiver coupled to the processor, wherein the WTRU is configured to:
receive, from a wireless network, sensing configuration information for performing sensing;
receive, from the wireless network, one or more reference measurement conditions;
perform candidate measurements of one or more reference signals received from the wireless network based on the sensing configuration information;
determine whether one or more of the candidate measurements satisfy the one or more reference measurement conditions; and
in response to the determination that the one or more of the candidate measurements satisfy the one or more reference measurement conditions:
determine reference measurements based on the one or more of the candidate measurements;
determine a validity duration of the reference measurements; and
report the reference measurements and the validity duration to the wireless network.

12. The WTRU of claim 11, wherein to perform the candidate measurements of the one or more reference signals comprises performing the candidate measurements of one or more reference signals during a reference measurement window.

13. The WTRU of claim 11, wherein the WTRU is configured to determine the validity duration of the reference measurements based on a number of the one or more of the candidate measurements and an uncertainty of each of the number of the one or more candidate measurements.

14. The WTRU of claim 11, wherein:
the one or more reference measurement conditions comprises one or more of a measuring condition, a quality condition, or a consistency condition; and
to determine whether the one or more candidate measurements satisfy the one or more reference measurement conditions comprises:
determining whether the measuring condition is satisfied;
determining whether the quality condition is satisfied; or
determining whether the consistency condition is satisfied.

15. The WTRU of claim 14, wherein to determine whether the measuring condition is satisfied comprises determining whether the WTRU is located in a configured measurement area.

16. The WTRU of claim 14, wherein to determine whether the quality condition is satisfied comprises determining whether a quality measurement of the one or more candidate measurements is greater than a threshold of the quality condition.

17. The WTRU of claim 14, wherein to determine whether the consistency condition is satisfied comprises determining whether a difference between two candidate measurements on two occasions is less than a threshold of the consistency condition.

18. The WTRU of claim 11, wherein to:
perform the candidate measurements of the one or more reference signals comprises performing the candidate measurements for a plurality of measurement occasions of received reference signals; and
determine whether the one or more of the candidate measurements satisfy the one or more reference measurement conditions comprises:
determining whether the candidate measurements for more than a predetermined number of measurement occasions satisfy the one or more reference measurement conditions; and
in response to the determination that the one or more reference measurement conditions are satisfied for more than the predetermined number of measurement occasions:
determining the reference measurements based on the candidate measurements for the more than the predetermined number of measurements occasions.

19. The WTRU of claim 11, wherein to:
perform the candidate measurements of the one or more reference signals comprises performing the candidate measurements for a plurality of measurement occasions of received reference signals; and
determine whether the one or more of the candidate measurements satisfy the one or more reference measurement conditions comprises:
determining whether the candidate measurements for more than a predetermined number of measurement occasions satisfy the one or more reference measurement conditions; and
in response to the determination that the one or more reference measurement conditions are not satisfied for more than the predetermined number of measurement occasions:
terminating the determination of reference measurements.

20. The WTRU of claim 11, wherein to:
perform the candidate measurements of the one or more reference signals comprises performing the candidate measurements for a plurality of measurement occasions of received reference signals; and
determine whether the one or more of the candidate measurements satisfy the one or more reference measurement conditions comprises:
determining whether the candidate measurements for more than a predetermined number of measurement occasions satisfy the one or more reference measurement conditions; and
in response to the determination that the one or more reference measurement conditions are not satisfied for more than the predetermined number of measurement occasions:
reporting invalid information of the candidate measurements to the wireless network; and
receiving, from the wireless network, updated sensing configuration information for performing further sensing.
